(19) United States
(12) Patent Application Publication
(10) Pub. No.: US 2010/0004121 A1
(43) Pub. Date: Jan. 7, 2010

(54) Short carbon nanotube for catalyst support, method of preparing the same, catalyst impregnated carbon nanotube using the same, and fuel cell using the catalyst impregnated carbon nanotube

(75) Inventors: Hyuk Chang, Seongnam-si (KR); Chan-ho Pak, Seoul (KR); Jian Nong Wang, Shanghai (CN)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/029,496

(22) Filed: Jan. 6, 2005

(30) Foreign Application Priority Data
Jan. 7, 2004 (KR) 10-2004-0000996

(51) Int. Cl. B01J 21/18; B01J 23/42

(52) U.S. Cl. 502/185; 502/182; 502/184; 977/742; 977/750; 977/752; 977/962

(57) ABSTRACT

The present invention is related to a short carbon nanotube for a catalyst support. In particular, the short carbon nanotube may be opened at both ends, a length of less than about 300 nm, and an aspect ratio in the range of about 1 to about 15. The short carbon nanotube has a broad surface area and better electric conductivity and is opened at both ends, thereby impregnating a metallic catalyst into the inner side of the carbon nanotube. Also, a catalyst impregnated carbon nanotube has a broad effective specific surface area, and thus, has an improved efficiency of catalyst utilization, can reduce an amount of the catalyst used and can efficiently diffuse a fuel. Accordingly, when catalyst impregnated carbon nanotube is used in a fuel cell, etc., improvements can be made in the pricing, power density of an electrode, and energy density of a fuel cell.

### CROSS-REFERENCE TO RELATED APPLICATIONS

This application claims priority to Korean Patent Application No. 2004-0000996, filed on Jan. 7, 2004, in the Korean Intellectual Property Office, the disclosure of which is incorporated herein in its entirety by reference.

### FIELD OF INVENTION

The present invention is related to a carbon nanotube. Specifically, the present invention is related to a short carbon nanotube for a catalyst support, a catalyst impregnated carbon nanotube using the same, and a fuel cell using the catalyst impregnated carbon nanotube.

### BACKGROUND

A carbon nanotube is a very fine cylindrical material measuring from about 1 nm to about 99 nm or less in diameter and from about 1 μm to about 99 μm or less in length. These cylindrical structures of carbon atoms take various forms: single-walled nanotubes, multi-walled nanotubes, or a rope structure. In the carbon nanotube, one carbon atom bonds to three other carbon atoms so as to form a hexagonal honeycomb. Depending upon its structure, the electronic properties, such as semiconducting properties, of the carbon nanotube vary. Because carbon nanotubes are very strong, there is also an interest in them for mechanical properties—about 100 times stronger than steel at one-sixth the weight. Thus, it can be variously applied in microscopic and macroscopic view. For example, research has been made to apply the carbon nanotube to a memory device, an electric amplifier or gas sensor, an electromagnetic wave shield, an electrode plate of an electrochemical storage device (secondary battery, fuel cell, or super capacitor), a field emission display, a polymer composite, and the like.

Recently, with growing concerns about the environment, the exhaustion of energy resources, and the commercialization of fuel cell automobiles, there is an increasing need for the development of reliable, high-performance fuel cells that are operable at an ambient temperature with high-energy efficiency.

Fuel cells are power generating systems that convert energy produced through the electrochemical reaction of fuel and oxidative gas directly into electric energy. Such fuel cells can be categorized into electrolyte fuel cells containing molten carbonate salt, which are operable at high temperatures, such as temperatures ranging from 500° C. to about 700° C., electrolyte fuel cells containing phosphoric acid, which are operable around 200° C., and alkaline electrolyte fuel cells and polymer electrolyte fuel cells, which are operable between room temperature and 100° C.

The polymer electrolyte fuel cells include proton exchange membrane fuel cells (PEMFCs) using hydrogen gas as a fuel source and direct methanol fuel cells (DMFCs) using liquid methanol directly applied to an anode as a fuel source. The polymer electrolyte fuel cells, which are emerging as a next generation clean energy source alternative to fossil fuels, have high power density and high energy conversion efficiency. In addition, the polymer electrolyte fuel cells function at an ambient temperature and are easy to hermetically seal and miniaturize, so they can be extensively applied to zero emission vehicles, power generating systems for home use, mobile telecommunications equipment, medical equipment, military equipment, and space equipment. The basic structure of a PEMFC as a power generator producing a direct current through the electrochemical reaction of hydrogen and oxygen is shown in FIG. 1. Referring to FIG. 1, a PEMFC may include a proton-exchange membrane 11 interposed between an anode and a cathode. The proton-exchange membrane 11 may be composed of a solid polymer electrolyte with a thickness in the range of about 50 μm to about 200 μm. The anode and cathode may include anode and cathode backing layers 14 and 15, for supplying reaction gases, and catalyst layers 12 and 13, respectively, in which oxidation/reduction of reaction gases occurs, forming gas diffusion electrodes (hereinafter, the anode and cathode will be referred to as “gas diffusion electrodes”).

In FIG. 1, a carbon sheet 16 has gas injection grooves and acts as a current collector. Hydrogen, as a reactant gas, is supplied to the PEMFC, and hydrogen molecules decompose into protons and electrons through an oxidation reaction in the anode. These protons reach the cathode via the proton-exchange membrane 11.

Meanwhile, in the cathode, oxygen molecules receive the electrons from the anode and are reduced to oxygen ions. These oxygen ions react with the protons from the anode to produce water. As shown in FIG. 1, in the gas diffusion electrodes of the PEMFC, the catalyst layers 12 and 13 are formed on the anode and cathode backing layers 14 and 15, respectively. The anode and cathode backing layers 14 and 15 are composed of carbon cloth or carbon paper. The surfaces of the anode and cathode backing layers 14 and 15 are treated so that reaction gases and water can easily permeate into the proton-exchange membrane 11 before and after reaction.

In contrast, while a DMFC has the same structure as a PEMFC, it uses methanol in a liquid state instead of hydrogen as a reaction gas, which is supplied to anode to produce protons, electrons, and carbon dioxide through an oxidation reaction by aid of a catalyst. Although the DMFC has inferior cell efficiency when compared to the PEMFC, the DMFC can be more easily applied to portable electronic devices than the PEMFC.

A catalyst used in the PEMFC or the DMFC is generally Pt or an alloy of Pt and another metal. To ensure cost competitiveness, it is necessary to reduce as much as possible an amount of the metallic catalyst used. Thus, to reduce the amount of the catalyst used while retaining or improving the level of performance of a fuel cell, an electrically conductive carbon material with a broad specific surface area has been used as a support and Pt has been dispersed in a fine particle state in the support to increase a specific surface area of the catalytic metal. The electrically conductive carbon material broadens the reaction area of reaction gases introduced and the catalytic metal particles are required for undergoing oxidation/reduction of a reaction fuel.

Generally, the catalyst layer is formed on the electrode backing layer through a known coating process after impregnating the catalytic metal particles into carbon powder particles. FIG. 2 is a TEM photograph of a catalyst impregnated carbon in which Pt catalyst particles are impregnated into a general spherical carbon support. According to FIG. 2, ultra fine Pt catalyst particles with a size ranging from 2 nm to about 5 nm are impregnated onto a surface of a carbon particle with a particle diameter of 0.1 μm. When using carbon powder particles, appropriate catalytic activity can be expected only when the amount of catalytic metal per the unit area of square centimeter is 3 mg or greater. However, since an amount of the used catalyst is still too much, it is necessary to improve an effective specific surface area of a catalyst.

As described above, since the carbon powder used currently has a limit as a support, a carbon support with a higher electrical conductivity and broader specific surface area was required. Thus, a general carbon nanotube was used as a catalyst support. FIG. 3 is a TEM photograph of a general single-walled carbon nanotube. This method using a carbon nanotube as a catalyst support was to utilize good electric conductivity of a carbon nanotube and contributed to the improvement of an electrochemical reaction efficiency of a catalyst and the electrode power density. However, as seen from FIG. 3, since the length of the carbon nanotube is in excess with respect to the diameter thereof, it is difficult to form a catalyst layer having a uniform distribution when forming a catalyst electrode. Also, since the carbon nanotube prepared by conventional methods has ends closed, a catalyst may be impregnated onto only an outer surface of the carbon nanotube and is very difficult to be impregnated into an inner surface of the carbon nanotube. As a result, a sufficient improvement in the power density is not observed.

In order to overcome these problems, a technique utilizing a carbon nanohorn was developed. The carbon nanohorn refers to a cylindrical material having a similar structure to a carbon nanotube having a part of a closed end cut. Since the carbon nanohorn is very short, a catalyst may be impregnated onto the surface of the carbon nanohorn. However, since an inner diameter of the carbon nanohorn is about 1 nm, it is impossible for catalyst particles having the optimal size of about 2 nm to about 3 nm to be impregnated. When the catalyst is impregnated onto only the outer wall of the carbon nanohorn, the broad surface area of the carbon nanohorn, which is the greatest advantage of the carbon nanohorn, is not utilized. Also, since one end is closed, the fuel source may not smoothly flow when it is used as the catalyst support for a fuel cell, thereby resulting in the deterioration of the fuel cell.

### SUMMARY OF THE INVENTION

The present invention is directed to a short carbon nanotube that may be used for a catalyst support. The carbon nanotube or the present invention may have a broad specific surface area and may be capable of having catalyst particles impregnated into the inside of the nanotube, thereby utilizing the maximum effective specific surface area of the catalyst. The present invention may also provide a catalyst impregnated carbon nanotube employing the short carbon nanotube. Additionally, the present invention may also provide a fuel cell using the catalyst impregnated carbon nanotube.

In one aspect of the present invention, the short nanotube, which may be used as a catalyst support, may have the characteristics of having both ends opened and may have a length of less than about 300 nm with an aspect ratio of about 1-15.

In a further aspect, the catalyst impregnated carbon nanotube having metallic catalyst particles with an average particle size in the range of about 1 nm to about 5 nm are impregnated into the inner wall and the outer wall of a short carbon nanotube. In particular, the carbon nanotube may have both ends opened, a length of less than about 300 nm, and an aspect ratio of about 1-15.

In another aspect, a fuel cell may be prepared employing the catalyst impregnated carbon nanotube of the present invention.

### BRIEF DESCRIPTION OF THE DRAWINGS

FIG. 1 is a schematic diagram illustrating a structure of a fuel cell.

FIG. 2 is a TEM photograph of a catalyst impregnated carbon with Pt catalyst particles impregnated into the general spherical carbon support.

FIG. 3 is a TEM photograph of a general single wall carbon nanotube.

FIG. 4 is a TEM photograph of a defective carbon nanotube, which are prepared for producing a short carbon nanotube according to the present invention.

FIG. 5 is an SEM photograph of a short carbon nanotube prepared in Example 1 of the present invention.

FIG. 6 is a TEM photograph of a short carbon nanotube prepared in Example 1 of the present invention.

FIG. 7 is a high resolution TEM photograph of a short carbon nanotube prepared in Example 2 of the present invention.

FIG. 8 is a schematic diagram illustrating a structure of a catalyst impregnated carbon nanotube prepared according to the present invention.

FIG. 9 is an SEM photograph of a catalyst impregnated carbon nanotube prepared in Example 3 of the present invention.

FIG. 10 illustrates the results of performance tests on a fuel cell prepared according to the present invention.

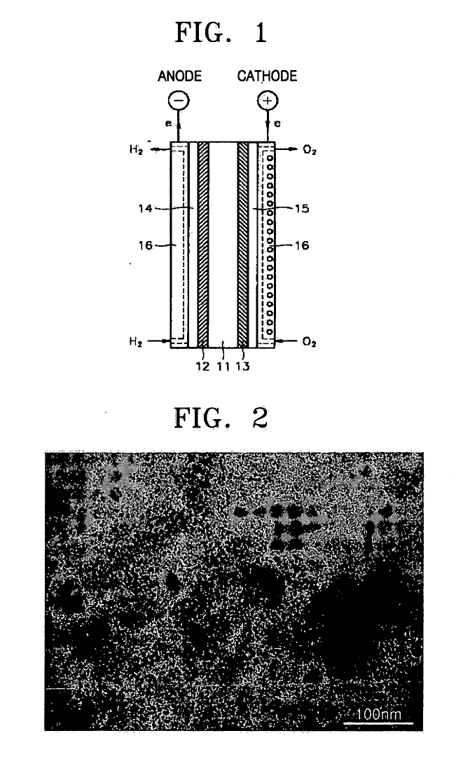

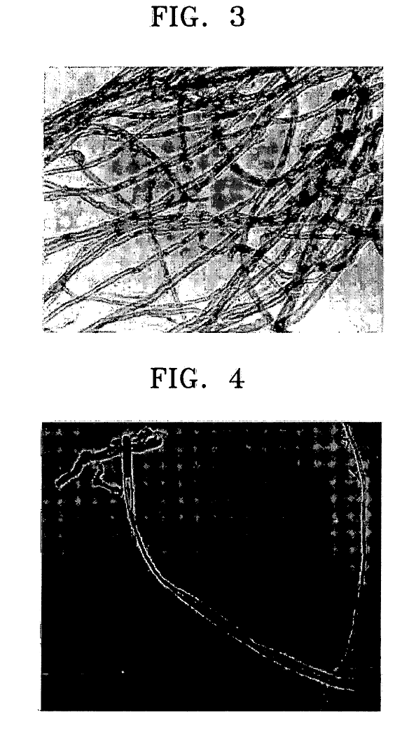

### DETAILED DESCRIPTION OF THE INVENTION

The present invention is directed to a short carbon nanotube, which may be used for a catalyst support, having both ends opened, a length of less than about 300 nm, and an aspect ratio of about 1-15. Thus, the catalyst may be impregnated in the inner side of the carbon nanotube and a reaction gas or liquid may be diffused through each opened end, thereby utilizing the maximum effective specific surface area of the catalyst particles.

In a particular embodiment, the diameter of the carbon nanotube may be in the range of about 10 nm to about 50 nm. When the diameter of the carbon nanotube is greater than about 50 nm, the entire specific surface area of a catalyst is undesirably reduced. In an additional embodiment, the length of the carbon nanotube may be less than about 50 nm and the aspect ratio of the carbon nanotube may be about 1-3. In particular, the shorter the length of the carbon nanotube, the more advantageous it is. When impregnating a catalyst into a carbon nanotube having a length and an aspect ratio within the above ranges, catalyst particles can have a maximum effective specific surface area. In a further embodiment, the structure of the carbon nanotube is not particularly restricted and may be multi-walled or single-walled. The carbon nanotube may have a metallic property because it can improve electrical conductivity when used as an electrode in a fuel cell.

Any method known by one of skill in the art may be used to prepare the carbon nanotube, such as arc discharge, laser vaporization, thermal chemical vapor deposition, and plasma enhanced chemical vapor deposition. In a specific embodiment, when an arc discharge or laser vaporization is used, synthesis yield of a carbon nanotube may be relatively low, and a large number of carbon clusters in an amorphous state may be produced besides the carbon nanotube during synthesizing. Additionally, these methods require a complicated purifying process, and it may be difficult to grow a large amount of carbon nanotube on a substrate with a large area. Alternatively, chemical vapor deposition may be used to synthesize a vertically-oriented carbon nanotube which has a high purity in high yield. Thus, chemical vapor deposition may be the most preferred method. However, it is very difficult to control the diameter and a length of a carbon nanotube and the length of a carbon nanotube prepared by this method may be several μm to tens μm, which is not preferred for use as a catalyst support.

According to an embodiment of the present invention, the short carbon nanotube for a catalyst support may be prepared by shortening the length of a conventional carbon nanotube through mechanical and chemical methods. However, since bonding forces between crystal carbons forming graphite are strong, processing may be difficult and a preparing process may be complicated. Thus, it is necessary to shorten the length of the carbon nanotube while preparing it by modifying the preparing process itself. A length of a carbon nanotube may be shortened by lowering the growth temperature during growth of the carbon nanotube of a chemical vapor deposition process using a catalyst. Also, in order to prevent continuous growth of the carbon nanotube, catalyst particles in the form of impurities may be applied to the stabilized carbide or graphite, or particles which are placed in the ends of a carbon nanotube, which is growing, to open the ends, thereby limiting growth of the carbon nanotube.

In an embodiment of the present invention, the carbon nanotube may be formed using a chemical vapour deposition method as follows. The short carbon nanotube for a catalyst support may be prepared by injecting carbon source gas at a constant flow rate into a reactor while supplying metal carbonyl as a catalyst source in a gas or liquid state to the reactor to prepare a carbon nanotube, and then rapidly transferring the carbon nanotube from a high temperature region to a low temperature region immediately after the beginning of the growth of the carbon nanotube.

In another embodiment, the catalyst particles may be formed in the same manner as the same general methods used for preparing the carbon nanotube. That is, a catalytic metal layer of cobalt, nickel, iron, or an alloy thereof may be formed on a substrate, and then the catalytic metal layer may be etched by purging an etchant gas at a constant flow rate to form nano-sized catalytic metal particles. The short carbon nanotube for a catalyst support may be prepared using the chemical vapor deposition. However, it is noted that defects may be formed at various positions on the carbon nanotube by rapidly halting the growth before the carbon nanotube significantly grows and then are cut, thereby opening both ends and controlling the length of the carbon nanotube to a maximum of about 300 nm.

FIG. 4 is a TEM photograph of a carbon nanotube having defects, obtained during preparing a short carbon nanotube for a catalyst support according to an embodiment of the present invention. Referring to FIG. 4, defects may be observed at various positions on the carbon nanotube and are cut to shorten carbon nanotube. The defects may occur because crystallization does not uniformly occur due to quick changes in the rate of growth of the carbon nanotube. According to the state of defects, the carbon nanotube may be cut during a growth phase to open an end or may be chemically treated with a strong acid once a growth phase is completed, to be first oxidized and cut at a defect portion so as to open an end.

The catalytic metal particles used in the method of preparing the carbon nanotube of the present invention may be formed by supplying metal carbonyl in a liquid or gas state or by dispersing catalytic metal particle precursors on a substrate, and then reducing and etching with an etchant gas. The metal carbonyl is not particularly limited as long as it is known in the art, and iron carbonyl (Fe(CO)₆), nickel carbonyl (Ni(CO)₄), may be used, for example. The etchant gas may be hydrogen or ammonia but other gases known to those skilled in the art may also be used. Additionally, the carbon source gas may be a common gas known to those skilled in the art, such as, methane, ethylene, or acetylene, for example.

In order to control the growth rate of a carbon nanotube by rapidly cooling immediately after beginning the generation of the carbon nanotube, a reactor may be vertically installed and an upper portion may be maintained at a temperature in the range of about 800° C. to about 1000° C. and a lower portion may be maintained at a temperature of less than about 100° C. by being thermally isolated from the upper portion, thereby transferring resultants produced in the high temperature region to the low temperature region. Alternatively, a cooling device may be placed at a side of a CVD apparatus and a reactor may be transferred to the cooling device by a slide-type mechanical device so as to rapidly cool it. Also, particles containing a catalyst may be sprayed using nitrogen as a carrier gas to transfer a carbon nanotube to a low temperature region.

The length of the short carbon nanotube for a catalyst support depends on how rapidly it is cooled, the flow rate of a carrier gas, and the diameter depends on the concentration and flow rate of the metal carbonyl supplied for forming a catalyst. Also, when the carbon nanotube is prepared after dispersing metallic catalyst particles on the substrate, the diameter of the carbon nanotube may be controlled by a degree of dispersion of the metallic catalyst particles.

According to embodiments of the present invention, the short carbon nanotube for a catalyst support, may be fabricated by plasma enhanced chemical vapor deposition (PECVD) as well as thermal chemical vapor deposition. In the PECVD, a carbon source gas may be injected between two electrodes of a reactor containing a metallic catalyst and microwaves or radio waves may be used to transform the carbon source gas into plasma which enables the carbon nanotube to grow on the electrodes. “Plasma,” as used herein, may refer to a collection of electrons and gas ions generated when free electrons generated by a glow discharge obtain sufficient energy to collide with gas molecules. Since the melting point of the glass substrate is about 600° C., it may be melted when using the conventional thermal chemical vapor deposition. Additionally, a carbon nanotube may be synthesized at a relatively low temperature when using the PECVD.

After preparing the short carbon nanotube according to the present invention, the shorter carbon nanotube may be prepared through an additional process. For example, it may be fabricated by ultrasonic treatment in a liquid under a strong oxidization atmosphere or high energy mechanical processing such as milling. In particular, when the additional shortening process is performed by a chemical method, impurities may be removed from the carbon nanotube and a suitable surface for a metallic catalyst to be impregnated may be obtained.

In a catalyst impregnated carbon nanotube according to another embodiment, metallic catalyst particles with an average particle size in the range of about 1 nm to about 5 nm may be impregnated onto an inner wall and an outer wall of a short carbon nanotube having both ends opened, a length of less than about 300 nm, and an aspect ratio of about 1-15. Since a broad surface area and high electrical conductivity of a carbon nanotube may be utilized, the amount of the impregnated catalyst per the unit area may be maximized, and a reaction gas or liquid may be diffused through both opened ends. Moreover, the area of a catalyst particle may be directly contacted with the reaction gas or liquid, resulting in increasing the effective specific surface area of the catalyst particle. FIG. 8 schematically illustrates a structure of a catalyst impregnated carbon nanotube prepared according to the present invention.

The catalyst impregnated carbon nanotube has similar effects to a conventional impregnated catalyst using carbon powder even at lower amounts and has superior effects to the conventional impregnated catalyst when using the same amount of a catalyst per the unit area. For example, when the catalyst impregnated carbon nanotube is used in an electrode of a fuel cell, the electrically conductive kinetics of the carbon nanotube ensure the highest electrical conductivity, and thus, an activity of catalyst particles can be maximized in relation to a collection of electric current produced. Also, a surface area of the carbon nanotube capable of impregnating a catalyst increases, and thus, a decrease in power density is prevented and energy efficiency may be improved even though reducing the amount of a catalytic metal per unit area. Accordingly, cost competitiveness of a product may be ensured. The catalyst impregnated carbon nanotube may be used in a fuel cell and as an electrode material in a general secondary battery or super capacitor.

The catalyst impregnated carbon nanotube may be prepared by preparing a short carbon nanotube for a catalyst support according to an embodiment of the present invention, and then impregnating catalyst particles, such as Pt, using a known method, such as gas phase reduction. In gas phase reduction, a metal salt solution of a catalytic metal precursor, such as a metal salt, in a solvent may be impregnated into the carbon nanotube support and dried, and then the metal salt may be reduced with hydrogen gas, for example, to impregnate the metallic catalyst. The catalytic metal precursor is not particularly restricted as long as it is a chloride of a catalytic metal. When the catalytic metal is Pt, examples of the catalytic metal precursor may include H₂PtCl₆ and PtCl₂.

The diameter of a carbon nanotube used in the catalyst impregnated carbon nanotube may be in the range of about 10 nm to about 50 nm. It is difficult to prepare a carbon nanotube below this range, and when the diameter is above this range the entire specific surface area of the catalyst may be undesirably reduced, thereby reducing catalytic efficiency. The length of the carbon nanotube may be a maximum of about 50 nm and an aspect ratio of the carbon nanotube may be about 1-3. As a carbon nanotube is shorter, it is more advantageous for impregnating a catalyst into the inside thereof. When impregnating a catalyst into a carbon nanotube having a length and an aspect ratio within the above ranges, catalyst particles can have the maximum effective specific surface area. Additionally, a structure of the carbon nanotube is not particularly restricted and may be multi-walled or single-walled. It may have a metallic property because it can improve electric conductivity when being used as an electrode in a fuel cell, and the like.

In another embodiment, metallic catalyst particles used in the catalyst impregnated carbon nanotube may include, but are not limited to, Pt or a Pt alloy when used in PEMFC or DMFC. The Pt alloy may be an alloy of Pt and Ti, Cr, Mn, Fe, Co, Ni, Cu, Ga, Zr, Hf, Ru, Ir, Pd, Os, or a mixture thereof, for example. In DMFC, methanol may be oxidized to generate carbon monoxide as a side product, which causes poisoning of a Pt catalyst. To prevent this poisoning, the Pt alloy catalyst may be used.

The entire specific surface area of the catalyst impregnated carbon nanotube may be about 1000 m²/g or greater. When the specific surface area is less than about 1000 m²/g, it is difficult to obtain catalytic metal particles with a fine size and catalytic efficiency is reduced.

The catalyst impregnated carbon nanotube may be used as an active component in an electrode of a fuel cell. The electrode for a fuel cell may be prepared in any conventional manner known in the art. For example, the catalyst impregnated carbon nanotube may be dispersed in a solution of an ionomer, such as Nafion, in isopropyl alcohol to prepare a slurry, and then the slurry may be coated on a waterproof carbon paper through spray coating and then dried to obtain an electrode.

The fuel cell may be PEMFC and DMFC, but is not so limited. Fuel cells may be divided into alkaline, phosphoric acid, molten carbonate salt, solid oxide, and solid polymer electrolyte fuel cells according to a type of an electrolyte used therein. In particular, when using a Pt catalyst, the catalyst impregnated carbon nanotube is suitable for alkaline, phosphoric acid, and solid polymer electrolyte fuel cells. Since DMFC has the same structure as the solid polymer electrolyte fuel cell, the catalyst impregnated carbon nanotube may also be used in DMFC. Since a liquid fuel may be efficiently diffused through the inside of the carbon nanotube having both ends opened, the catalyst impregnated carbon nanotube is particularly suitable for DMFC.

### EXAMPLES

### Specific Example 1

### Preparation of a Carbon Nanotube for a Catalyst Support

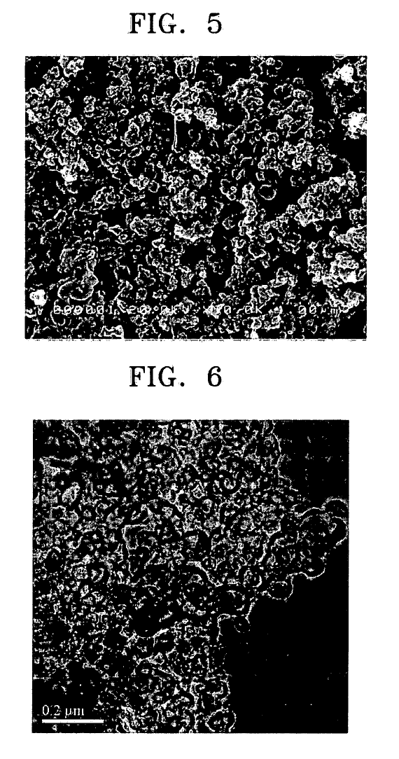

Nitrogen gas was purged into a vertical reactor at a rate of about 500 standard cubic centimeters per minute (sccm) under atmospheric pressure while raising the temperature of the upper portion of the vertical reactor to about 500° C. Then, to form the catalyst, iron carbonyl was supplied to the reactor in a gas state at a rate of about 50 sccm while holding the temperature constant at about 1000° C. Next, acetylene as a carbon source gas was supplied to the reactor at a rate of about 10 sccm under atmospheric pressure for about 60 minutes resulting in the generation of the carbon nanotube. Within 1 minute of the synthesis of the carbon nanotube, the carbon nanotube was transferred to a lower portion of the reactor, which was thermally isolated from the upper portion and held at a temperature maximum of about 100° C., to obtain a short carbon nanotube. The resultant carbon nanotube had a diameter of about 50 nm and a length of about 50 nm. An SEM photograph and a TEM photograph for the obtained carbon nanotube are illustrated in FIGS. 5 and 6, respectively.

### Specific Example 2

### Preparation of a Short Carbon Nanotube for a Catalyst Support

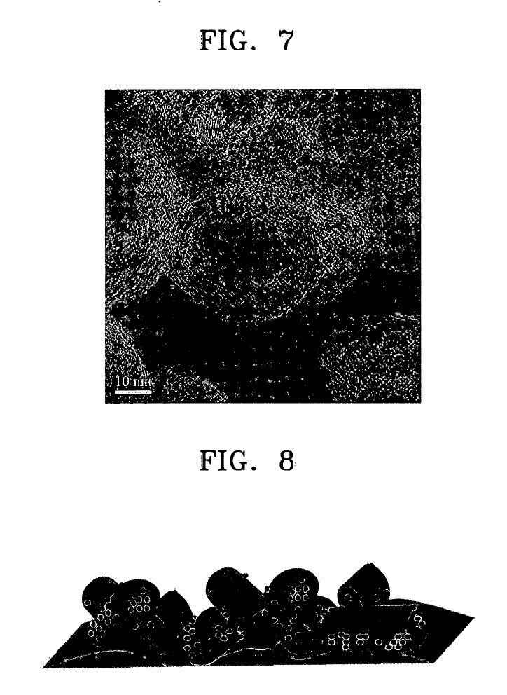

A short carbon nanotube was prepared in the same manner as Example 1 except that a flow rate of the carrier gas was about 700 sccm and a flow rate of iron carbonyl was about 30 sccm. The resultant carbon nanotube had a diameter of about 30 nm and a length of about 40 nm. A high resolution TEM photograph of the resultant carbon nanotube is illustrated in FIG. 7.

### Specific Example 3

### Preparation of a Catalyst Impregnated Carbon Nanotube

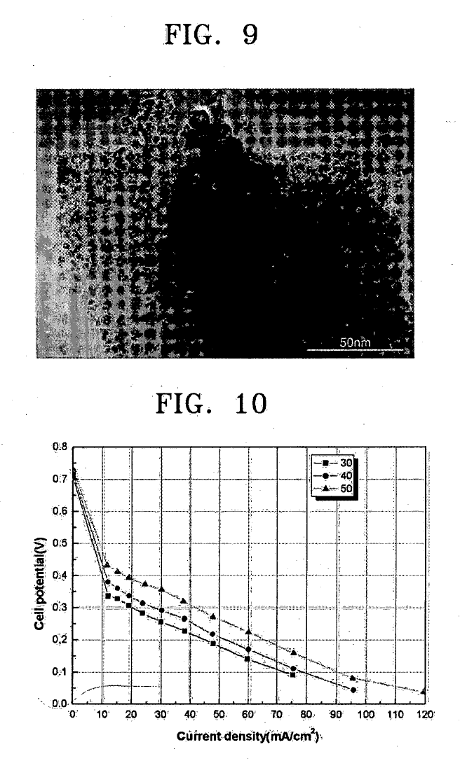

About 0.5 g of the carbon nanotube prepared in Example 1 was placed in a vinyl bag and about 0.9616 g of H₂PtCl₆ was weighed and dissolved in 0.8 ml of acetone. The solution was placed in the vinyl bag containing the carbon support and mixed, and then 0.35 ml of acetone was further added thereto and dissolved by thoroughly shaking. This process was repeated once again such that the total amount of acetone added was 1.5 ml. The mixture was dried in air for 4 hours, then was transferred to a crucible and finally dried in a drier at about 60° C. overnight. Then, the crucible was placed in an electric furnace under nitrogen flow for about 10 minutes. Next, the nitrogen gas was replaced with hydrogen gas and the temperature in the electric furnace was raised from room temperature to about 200° C. and maintained for 2 hours to reduce a Pt salt impregnated into the carbon support. The hydrogen gas was replaced with nitrogen gas and the temperature in the electric furnace was raised to about 25° C. at a rate of about 5° C./minute and maintained at about 250° C. for about 5 hours, and then cooled to room temperature. The resultant catalyst impregnated carbon nanotube had a concentration of impregnated Pt equal to about 60% by weight was obtained. An SEM photograph of the obtained catalyst impregnated carbon nanotube is illustrated in FIG. 9.

### Specific Example 4

### Manufacturing of a Fuel Cell

The catalyst impregnated carbon nanotube prepared in Example 3 was dispersed in a dispersion solution of Nafion 115 in isopropyl alcohol to prepare a slurry and was coated on a carbon electrode through a spray process to obtain a concentration of about 1 mg/cm² of the coated catalyst based on the Pt concentration. Then, the electrode was passed through a rolling machine to enhance adhesion between a catalyst layer and a carbon paper, resulting in the generation of a cathode. Additionally, an anode prepared using a commercially available PtRu Black catalyst was used as the anode to prepare a unit cell.

### Specific Example 5

### Test of Performance of the Unit Cell

Performance of the unit cell prepared in Example 4 was measured at 30° C., 40° C., and 50° C. while supplying 2M methanol and air in excess. The results are illustrated in FIG. 10. Although the fuel cell of the present invention used the catalyst per the unit area in an amount of 1 es than about 1 mg/cm², it had similar or superior performance to a conventional fuel cell using a catalyst per the unit area in an amount of about 2-4 mg/cm².

As described above, the short carbon nanotube according to the present invention may have a broad surface area and better electric conductivity. Furthermore, the carbon nanotube may have both ends opened a metallic catalyst impregnated onto the inside of the nanotube. Also, the catalyst impregnated carbon nanotube has a broad effective specific surface area, and thus, has improved efficiency of catalyst utilization, may reduce the amount of catalyst used and can efficiently diffuse a fuel. Thus, when the catalyst impregnated carbon nanotube may be used in a fuel cell improvements may be made in pricing the power density of the electrode, and the energy density of a fuel cell.

1-4. (canceled)

5. A catalyst impregnated carbon nanotube for using as an active component in an electrode of a fuel cell in which metallic catalyst particles with an average particle are impregnated into an inner wall and an outer wall of a short carbon nanotube having both ends opened, a length of less than 50 nm, and an aspect ratio in the range of about 1 to about 3,
wherein the catalyst impregnated carbon nanotube has a 60% by weight of metallic catalyst particles.

6. The catalyst impregnated carbon nanotube for using as an active component in an electrode of a fuel cell of claim 5, wherein the nanotube has a diameter in the range of about 10 nm to about 50 nm.

7. The catalyst impregnated carbon nanotube for using as an active component in an electrode of a fuel cell of claim 5, wherein the metallic catalyst particles having an average particle size in the range of about 1 nm to about 5 nm are impregnated onto an inner wall and an outer wall of the short carbon nanotube.

8. The catalyst impregnated carbon nanotube for using as an active component in an electrode of a fuel cell of claim 5, wherein the carbon nanotube has a multi-walled structure or a single-walled structure.

9. The catalyst impregnated carbon nanotube for using as an active component in an electrode of a fuel cell of claim 5, wherein the metallic catalyst particle is Pt or a Pt alloy.

10. The catalyst impregnated carbon nanotube for using as an active component in an electrode of a fuel cell of claim 9, wherein an element used in the Pt alloy is selected from the group consisting of Ti, Cr, Mn, Fe, Co, Ni, Cu, Ga, Zr, Hf, Ru, and a mixture thereof.

11. The catalyst impregnated carbon nanotube for using as an active component in an electrode of a fuel cell of claim 5, wherein the nanotube has a specific surface area of greater than about 1000 m²/g.

12. A fuel cell, comprising:
a catalyst impregnated carbon nanotube for using as an active component in an electrode of a fuel cell wherein metallic catalyst particles having a particle size in the range of about 1 nm to about 5 nm are impregnated into an inner wall and an outer wall of a short carbon nanotube having both ends opened, a length of less than 50 nm and an aspect ratio in the range of about 1 to about 3,
wherein the catalyst impregnated carbon nanotube has a 60% by weight of metallic catalyst particles.

13. The fuel cell of claim 12, wherein the carbon nanotube has a diameter in the range of about 10 nm to about 50 nm.

14. (canceled)

15. The fuel cell of claim 12, wherein the carbon nanotube has a multi-walled structure or a single-walled structure.

16. The fuel cell of claim 12, wherein the metallic catalyst particle is Pt or a Pt alloy.

17. The fuel cell of claim 16, wherein an element used in the Pt alloy is selected from the group consisting of Ti, Cr, Mn, Fe, Co, Ni, Cu, Ga, Zr, Hf, Ru, and a mixture thereof.

18. The fuel cell of claim 12, wherein the nanotube has a specific surface area of greater than about 1000 m²/g.

19-22. (canceled)
